(19) United States
(12) Patent Application Publication
(10) Pub. No.: US 2001/0032161 A1
(43) Pub. Date: Oct. 18, 2001

(54) Method of valuing, marketing and buying a commodity lot

(75) Inventors: Kenneth D. Thomas, Kansas City, MO (US); A. Paul Armbrust, Kansas City, MO (US); Michael T. Sweat, Kansas City, MO (US)

Correspondence Address: SPENCER, FANE, BRITT & BROWNE, 1000 WALNUT STREET, SUITE 1400, KANSAS CITY, MO, 64106-2140, US

(73) Assignee: Farmland Industries, Inc., Kansas City, MO (US)

(21) Appl. No.: 09/825,752

(22) Filed: Apr. 4, 2001

Related U.S. Application Data
(60) Provisional application No. 60/197,247, filed on Apr. 14, 2000.

(51) Int. Cl. G06F 17/60

(52) U.S. Cl. 705/36

(57) ABSTRACT

A method of valuing, marketing and buying a commodity lot is provided in which a particular lot of a commodity is tested to determine an amount of a value-trait present in the particular commodity lot; a trait-premium is assigned to the amount of the value-trait, a base-value of the particular commodity lot is adjusted in relation to the trait-premium. The base-value and the trait-premium are posted electronically as a lot-information to allow a commodity purchaser to determine if the particular commodity lot meets the purchaser's desired criteria.

### FIELD OF THE INVENTION

The present invention relates to a method of valuing, marketing and buying commodities, such as grain, or tubers, or other agricultural commodity based upon determining the value of particular production-benefitting traits (value-traits) possessed by any particular portion, or lot, of the commodity. The standard market value for the commodity can then be increased or decreased by the additional value presented by the traits possessed by the particular lot on which the traits have been determined.

### BACKGROUND OF THE INVENTION

Traditionally, commodities have been valued by, generally, treating all lots of the commodity as identical in terms of their end-use qualities and production traits. By way of example, wheat is grown by farmers and shipped to a local terminal, or cooperative, where the grain is assessed for basic traits relating to the general quality of the grain such as moisture content, weight, protein content, grade and dockage (i.e. damage, foreign material, shrinkage, breakage, defects) in the particular farmer's shipment. A general valuation is then placed on the wheat received from the farmer, and the wheat is intermixed with other shipments of wheat brought by other farmers from other fields. These mixed shipments of wheat are offered on the marketplace and valued according to the very general traits possessed by the particular mixture of wheat.

Purchasers of the wheat then pay the market rate per bushel for the wheat and may slightly increase or decrease the price paid for the wheat depending upon the general quality of the particular wheat determined by the basic traits. Experienced wheat purchasers may become aware of certain production efficiencies to be gained from purchasing a particular variety of wheat or production efficiencies to be gained by purchasing wheat from a particular area of the country. The experienced buyer can then gain production savings, without paying a higher price for the wheat, by purchasing wheat containing particular traits that yield a savings in the production processes for which the wheat is used.

Inherent in this development of different valuable traits being associated with different varieties of a commodity, or different values for a commodity having slightly different end-use qualities, is the shifting of the additional value gained by the valuable traits of a particular lot of the commodity away from the commodity producer and to the end user of the commodity who can identify the valuable traits of different commodity lots and then formulate the commodity into a final product such as baked goods. Under the historical models of commodity valuation and sales, the net economic benefit to the end-user would be reduced significantly by the costs associated with identifying the particular commodity lot. For example, under the historical models of valuation, an end-user may have incurred expenses in paying an employee to locate a commodity having certain traits that provide a production benefit to the end-user. Also, most commodity producers did not test a sample of their commodity lots to determine the existence of traits that provide a production benefit to end-users; thus once a commodity lot was located, end-users (or their agents) would either have to visit the location of the particular commodity lot to test it, or request that a sample be taken from the lot.

Additionally, under the historical models of commodity valuation and sales, there often exists a middle-man purchaser who supplies the commodity to an end-user. In the case of a middle-man, or buyer, wheat or another commodity, the buyer would be able to identify a flour mill or a bakery having specific demands for a particular type of wheat, or a wheat having certain traits that provide a production benefit to the end-user. The middle man could then locate that particular grain and sell it to the flour mill or the bakery. Of course the middle-man would sell the commodity to the end-user at an increased price to make up for the middle-man's expenses incurred in locating the wheat and to allow the middle-man to profit from his efforts.

Whether an end-user of a commodity personally locates a lot of the commodity having desired traits, or if a middle-man supplies an end-user with such a commodity, the costs of locating the commodity often outweigh the economic benefit gained in using that commodity. Therefore, it would be beneficial to the end-users of the commodity if a method existed for the commodity producers or the local commodity terminal dealing with the commodity producer, to identify particular traits of additional value in any particular lot of a commodity, and then distribute the information regarding that particular commodity lot to commodity buyers who would pay directly for the additional value presented by the traits possessed by the lot of the commodity. Such a method would reduce the end-users' cost associated with locating the commodity lot. Since location costs would be significantly reduced, trait-specific commodities could then be used in many situations where such use would traditionally have been economically inconceivable.

Therefore, if a producer of wheat determined that various valuable wheat characteristics, factors or traits were present in a particular lot of wheat, the producer could advise the end users of the wheat (i.e., flour mills and bakeries) of these advantageous characteristics, factors or traits, and capture a premium price for such characteristics, factors or traits which the purchaser recognizes as providing money saving production efficiencies and end product benefits. In this manner the producer could capture the additional value for a commodity originating from a particular area of the country or being of a particular variety or having particular characteristics, factors or traits, while at the same time significantly reducing the end-users' costs associated with locating trait-specific commodities.

Examples of the economic production benefit gained by the end user of the commodity are traits which can reduce mixing time, or baking time. Additionally, end-users may have a need for a commodity having specific compositional features so that the commodity can be used for a specific purpose. By equipping the commodity producer's terminal with the means of determining and disseminating and valuing these commodity traits which will vary from commodity lot to commodity lot, the producer of the commodity and the terminal can shift the realization of economic value in the particular commodity lot from capture at the user end of the distribution chain and back toward the producer end of the commodity distribution chain.

### SUMMARY OF THE INVENTION

In general, the present invention is directed to a method of recognizing commodity traits which provide additional value to end users of the commodity and calculating an increased value or trait premium for the particular commodity lot possessing traits which are valued to end users, and then disseminating this identified value directly to commodity purchasers so that the premium value identified for a particular commodity lot can be realized closer to the producer end of the commodity distribution chain. The present invention can incorporate all or a portion of the above-identified inventive elements depending on the particular embodiment of the invention.

More particularly, the present invention provides a method of identifying, valuing and marketing specific lot value-traits and specific lot character factors relating to particular lots of a commodity such as grain. Traditionally, commodities such as wheat, have been valued based upon their basic traits that relate to the overall quality of the commodity such as grade, protein content, moisture content, dockage, test weight, damage, foreign material, shrinkage, breakage and total defects. The value-traits of a commodity differ from the basic traits of the commodity in that value-traits are traits of the commodity that provide a production benefit to the end-user of the commodity. The production benefit can be in the form of a savings in the end-users' production process, or it can be in the form of a suitability of the commodity for a specific purpose. Usually, value-traits are determined through testing that applies specifically to the end use of the commodity; whereas, basic traits are not dependant upon the end use of the commodity. Examples of specific value-traits of grain include wheat variety, absorption, stability and peak time. The value-traits of grain also can include information which is important to millers such as kernel weight, tempered weight, extraction, flour, feed. When the particular lot is suited to use as flour, the additional value-traits of falling number and wet gluten can be included. When the grain may be of interest to a baking company for use as flour, the following additional value-traits can be provided: mix time, dough characteristics, external, grain, texture, crumb color, volume, total bake score. In addition, bakers will wish to examine the Farinograph of the lot which shows in graphic form the absorption and peak time and stability and MTI for flour made from the grain lot. Examples of character factors of grain include attributes that are external to the commodity such as lot quantity, lot shipping logistics, lot geographic location, or lot availability.

A combination of several of these lot character factors and lot value-traits can be used together to determine the economic benefits and advantages which a particular grain lot can offer to the mill or bakery that purchases the grain lot. The utility of these economic benefits and advantages are appreciated by mills and bakeries and a premium price will be paid by mills and bakeries for grain lots which possess the desired character factors and value-traits.

The present invention allows the producers of grain to identify grain lots having character factors and value traits which can command per bushel price premiums from mills and bakeries. The present invention provides a method which allows mills and/or bakeries to identify the grain lots having particularly desirable value-traits and to identify additional lot character factors such as lot quantity, geographic location, or availability, and to pay the producer directly for the added value represented by these desirable traits and factors.

In operation, the character factors for a particular lot are identified, and a character-value, or premium, is assessed for each character factor. The presence and/or amount of each value-trait is obtained through laboratory testing of grain samples from the particular grain lot and a trait-premium is assessed. The character factors and value-traits, along with any trait-premiums and character-values are combined into a lot-information for each grain lot which is then posted on an electronic bulletin board, or at a Global Communications Network Address such as an Internet web site or the like. A potential grain purchaser, or user, can inspect the various traits and factors possessed by various grain lots and, thereby purchase particular grain lots, or portions thereof, which are best suited to the user's particular needs including shipping cost needs and grain trait needs. The customer is able to purchase grain containing precisely the traits and factors of interest to the purchaser, and the seller of the grain is able to present to potential purchasers particular grain lots having specific grain traits and factors which enhance the economic value of the particular grain lot.

Another embodiment of the invention can provide the ability for potential purchasers of grain lots to request sample quantities of particular grain lots so that actual production testing may be conducted on the particular grain lot prior to large scale purchases. In another embodiment of the invention, the method combines a grain lot purchasing center through which buyers can effect purchases of lots of grain, or portions thereof, directly from the producer or terminal or elevator at which the grain lot is housed.

Yet another component of the invention allows the end user of a grain lot to track and document exactly where the grain lot originated and to determine information regarding how the grain lot was grown. Due to the early segregation and testing and identification of grain lots under the present method, the end user can trace or track the exact genesis of the grain being purchased. The end user can then contact the grower to determine and examine the growing techniques used on the grain. Examples of growing techniques include fertilizers used, whether the grain qualifies as “organic grain” or whether the seed used was genetically modified seed. These types of issues, particularly issues relating to genetically engineered crops and foods, are of increasing importance to consumers. Genetic engineering has been highly controversial due to many fears that the swapping of DNA between unrelated crop species will create health and environmental hazards. Therefore, higher prices can be charged for both the grain and the products produced from that grain when the grain lot can be specifically tracked and its growing history and genetic background verified.

Typical value-traits that relate to the performance of a grain in end-users' production processes are:

Absorption: The amount of water required to be added to a particular flour for it to function optimally in an application (usually the amount required to make the best possible bread dough), expressed as a percent of the flour weight.

Stability: The relative resistance of a product to undesirable change. For dough, the term generally refers to the range of fermentation time through which an acceptable product can be obtained. For many food products, such as bread, stability includes the resistance to deleterious microbiological processes.

Peak time: During a Farinogram test performed on a dough, the time, to the nearest half minute, between the first addition of water and the development of the dough's maximum consistency, or minimum mobility, i.e., the point immediately before the first indication of weakening.

MTI: The difference, in Brabender units, between the top of the curve at the peak and the top of the curve measured five (5) minutes after the peak is reached.

Extraction: Amount of wheat kernel that is actually milled into usable flour. Usually expressed as a percentage.

Extraction flour/feed ratio—Amount of flour verses feed derived after milling.

Falling Number: Test used to measure the level of diastatic activity in the flour; it has some value for determining the suitability of flour for bread making.

Wet Gluten: A measurement relating to the amount of protein present in a flour after the grain has been milled.

Mix Time: A measurement relating to how a particular grain will perform in a baking process.

Dough Characteristics: A measurement relating to how a particular grain will perform in a baking process.

External: A measurement relating to the external appearance of a final baked product using a particular grain.

Grain: A measurement relating to the fibrous quality of a final baked product using a particular grain.

Texture: A measurement relating to the texture of a final baked product using a particular grain.

Crumb Color: A measurement relating to the crumb color of a final baked product using a particular grain.

Volume: A measurement relating to the volume of a final baked product using a particular grain.

Typical value-traits that demonstrate a usefulness of for end-users' specific purposes are:

Kernel Weight: A function of kernel size and kernel density, usually expressed in grams per 1,000 kernels.

Tempered weight: Kernel weight plus water weight.

Variety: A taxonomic subdivision of a species consisting of naturally occurring or selectively bred populations or individuals that differ from the remainder of the species in certain minor characters.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention.

### DESCRIPTION OF THE DRAWINGS

Preferred embodiments of the invention, illustrative of the best modes in which the applicant has contemplated applying the principles, are set forth in the following description and are shown in the drawings and are particularly and distinctly pointed out and set forth in the appended claims.

FIG. 1 is a block diagram showing the general activities of the present method; and

FIG. 2 is a flow chart showing, generally, the method steps associated with use of the present inventive method with a grain commodity.

### DESCRIPTION OF THE PREFERRED EMBODIMENTS

The preferred embodiment hereinafter described is that of a method of valuing, marketing and buying a commodity lot, wherein the commodity is a grain or wheat. It will be appreciated that the described method can be utilized with any commodity for which end-user production benefits (value-traits) may be recognized.

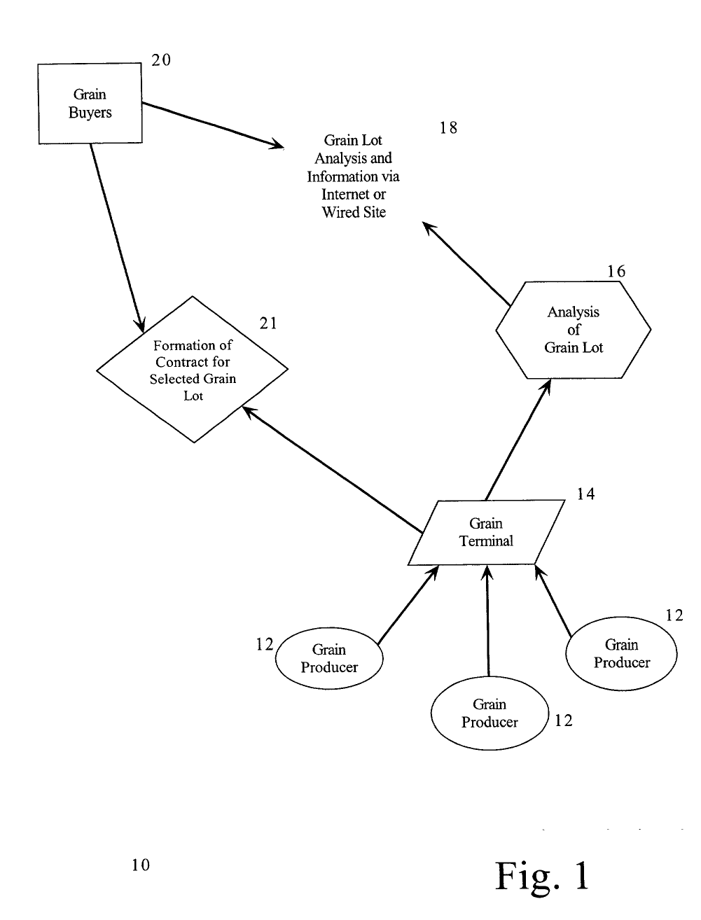

Referring to FIG. 1, a block diagram of the inventive method is presented. In general, the scheme utilized in the inventive method comprises Grain Producers 12, presenting their grain to a grain terminal or elevator or other central location 14 where the grain is to be stored as separate lots. The grain of Grain Producers 12 may be mixed together at terminal 14 or the grain of each producer may be held separately. Once the grain is deposited at grain terminal or elevator 14, samples are taken from each grain lot held at terminal 14, and the samples are shipped to a laboratory 16 for analysis of the amount of various value-traits which the grain may contain. Alternatively, the producer may keep the grain on the farm and send in a sample for testing. These value-traits will consist of various characteristics inherent in the commodity which can provide differing manufacturing process efficiencies to end users of the commodity, or can provide additional value to the commodity such as higher levels of nutrients in a baked end product. By way of example, wheat value-traits can consist of the following: wheat variety; absorption; stability; and peak time. Additional basic traits of wheat can also be identified for each lot including characteristics related to wheat quality such as grade, dockage, test weight, protein, moisture, damage, foreign material presence, shrunk broken percentage, and a total defects rating.

Other value-trait characteristics which can be analyzed and presented are milling quality characteristics such as kernel weight, tempered weight, extraction, flour, and feed.

If the wheat or grain is to be used as a flour, relevant value-traits would include moisture content, falling number, and wet gluten.

Additional value-trait information regarding wheat in particular would be baking test characteristics such as absorption, mix time, dough characteristics, external, grain, texture, crumb color, volume. All these bake-test characteristics then are combined to provide a total bake score for the particular lot of wheat. Yet another aspect of information which would be presented would be a Farinograph of the wheat which would be presented on line as a j-peg or gif file. The Farinograph would show the buyer the absorption peak time stability and MTI for the particular lot of wheat.

All this information is obtained during the laboratory analysis 16 of FIG. 1. This information is combined with additional information, or character factors, such as information relating to the location of the wheat, the quantity of the wheat available, the lot number of the wheat, the board price (or base-value) for the particular Board of Trade location of the wheat, the delayed price and the location basis by zone and rail access. These features can be included with p the value-traits which have been determined for the particular lot of wheat during laboratory analysis 16. All of the above value-traits, basic traits and additional lot data (character factors) are then posted as a lot-information on a bulletin board or Internet website or other electronic medium to allow a buyer to examine the various lots of wheat and the traits which can be found in those lots of wheat. The purchaser can then select a particular lot of wheat which meets very specific desired criteria which the buyer may wish to fulfill. The buyer can examine all of the very particular lab analysis characteristics or value-traits which have been analyzed during laboratory analysis 16 and select the lot of wheat which most closely conforms to the desired characteristics or predetermined criteria of the buyer. The purchaser or buyer is able to then engage in formation of a contract 21 for purchase of the particular grain lots which have been selected through examination of the lot-information posted on the Internet or bulletin board 18.

One embodiment of the present invention allows the buyer to specify a parameter, such that the buyer will only view lot-informations for particular lots of wheat that meet the buyer's parameter. Another embodiment of the present invention arranges lot-informations into a distinct order so that the buyer may quickly determine which particular lots meet the buyer's desired criteria. For example, lot-informations for grain could be arranged in descending order based upon the absorption for each lot.

It is important to appreciate that by having the wheat characteristics determined by lab analysis by the grain terminal 14, that price increases due to value-traits of the wheat can be added to the board price which would normally be paid by the potential purchaser. As these additional characteristics have been determined on a lot-by-lot basis by the grain terminal 14 through lab analysis 16, the additional value or economic benefits attributable to the various value-traits can be added to the board price of the wheat as a trait-premium thereby capturing the economic benefit of this added value for the grain terminal 14 and the grain producer 12 rather than allowing the economic benefit to be realized by the wheat buyer or the end user of the wheat through the various economic efficiencies represented by the value-traits in the lowering of production costs to the end-user of the grain. Additionally, a character-value can be assessed and added to the board value for certain character factors that further increase the buyer's efficiencies.

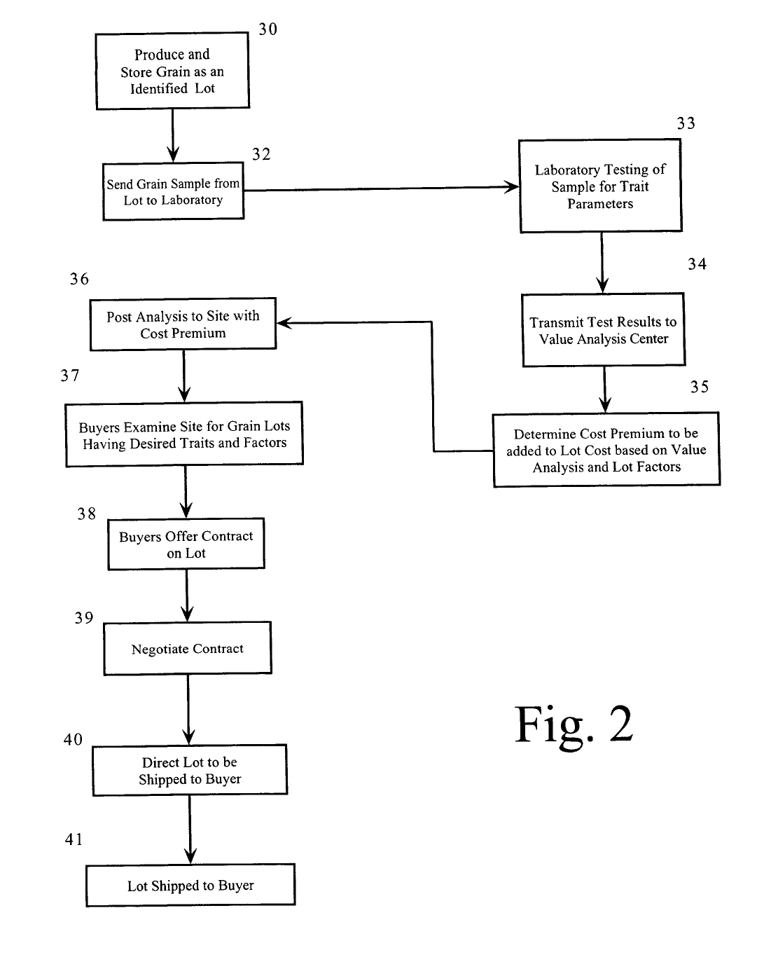

Referring now to FIG. 2, a general flow chart of the sequence engaged in the present method will be described. Initially, grain is produced by a farmer, and the produced grain 30 is stored on the farm or at a grain terminal or elevator where the grain is then held until a contract to purchase the grain is formed. While the grain is being held, a sample of the grain from each lot is taken and shipped to a laboratory 32 for analysis of the various value traits of the grain. The sample is received at the laboratory and is tested for the various value-traits or characteristics 33 which are considered to be of interest in assessing whether additional value should be attributed to the particular lot of grain. The amount of each value-trait for which the sample has been tested is determined, and the information is sent from the laboratory to the value analysis center 34 where the trait-premium and any character-factor premium to be added to or subtracted from the cost of the grain lot is determined 35.

The analysis and cost premium is then sent to the Internet website or other electronic information system 36 on which the results are to be displayed. The value-traits or characteristics determined at the laboratory are then received at the posting site where the trait-premium to be charged for each lot of wheat is posted along with the additional premium charges, such as the character-value, to be added to the basic board price of the lot of wheat. Once this information is posted to the electronic site, buyers for millers or flour mills can examine the site to identify particular grain lots which are possessed of the particular characteristics or value-traits which are of interest to the buyer or miller or baker 37. Once the buyer of the wheat or the baker or flour mill has identified the grain lots of particular value to them, an offer is made for the particular lots, or portions thereof, of wheat 38.

In one embodiment of the invention, an on-line Internet website allows the buyers of wheat to examine the information about the various lots of wheat and to place their offers for contracts on the lots of wheat. Once the offer is received, it is further negotiated or accepted 39, and the purchase of those particular lots of wheat, or portions thereof, is then concluded. Once a contract is concluded, the purchased grain is then directed to be shipped to the buyer 40 according to the various shipment instructions the buyer has included in the contract negotiation. The information regarding the shipment of the wheat is then communicated to the holder of the wheat which then effects the shipment of the wheat to the buyer 41.

It will be appreciated that the above described invention can be utilized to value, market or buy any commodity for which end-user production benefits, or value-traits, may be identified. Although the described embodiment relates to an agricultural commodity, it is understood that the inventive method is not so limited. The disclosed invention may be utilized to value, market or buy any product of agriculture, product of mining, economic good, article of commerce, or other mass-produced unspecialized product. Examples of commodities for which value-traits may be recognized can include fruits, nuts, vegetables, minerals, cotton, oils, and metals.

In the foregoing description, certain terms have been used for brevity, clearness and understanding; but no unnecessary limitations are to be implied therefrom beyond the requirements of the prior art, because such terms are used for descriptive purposes and are intended to be broadly construed.

In the context of the invention disclosed herein, the term “lot” is intended to indicate any quantity of a given commodity. It is understood that the term “lot” may sometimes indicate a specific fixed amount when used in the context of certain commodities. In a phantom example, persons dealing in the sale of cattle may recognize a “lot” of cattle as always being the same fixed number of cattle, such as 100 cattle per lot. Although, trade definitions may exist for the term “lot” for some commodities, no such limited definitions are intended to be applied to the use of “lot” in the context of the present invention.

Although the inventive method has been generally described to apply to value-traits that increase the value of a given commodity, it is understood that value-traits may exist that actually reduce the value of a particular lot of a given commodity. Additionally, a low amount of, or the absence of, a given value-trait may decrease the value of a particular lot of a given commodity. Therefore, the term “premium” is broadly defined to include either a positive or a negative value.

In the context of the present invention, the term “producer” is intended to include broadly commodity producers (such as farmers, miners, manufacturers, and such), and employees and/or agents of a commodity producer. Additionally, for the purposes of valuing and marketing a commodity disclosed in the present invention, a “producer” can include other non-end-users of the commodity, such as a grain terminal or farmer owned cooperative.

The description and illustration of the inventions is by way of example, and the scope of the inventions is not limited to the exact details shown or described. It is noted that all of the examples of “value-traits” listed above do not correspond to any of the basic traits for the commodity. Although no such examples have been given, it is not beyond the scope of the instant invention to have a basic trait that is also a value-trait. A phantom example is now described for wheat. Protein content is a basic trait of wheat in which varying premiums are assessed for varying levels of protein present in a particular lot of wheat. Protein is considered a basic trait because the premium paid for increased levels of protein in a lot of wheat are based upon an increase in the quality of the wheat due to the level of protein rather than a production benefit. If however, an additional premium, apart from the basic trait protein premium, could be assessed for wheat having a specified level of protein because that protein level shortens mixing time (or provides some other production benefit), in that instance, protein would be both a basic trait and a value-trait.

While the mere recognition of a certain characteristic or trait in a particular lot of a commodity may in and of itself indicate an end-use/production benefit, it is understood that many value-traits may require a separate assessment and/or extrapolation to recognize the production benefit. An example of a value-trait which, on its face, indicates a production benefit would be mix-time for wheat. Mix time is a measurement of how a particular wheat will perform in a baking (end-use) process. The lower the mix-time, the higher the benefit to an end-user. A phantom example of a trait that requires a separate assessment to recognize the production benefit will now be described for apples. Apples are often used to make pies. A trait of apples is that they have a measurable juice content. By itself, the juice content of an apple does not indicate an end-user/production benefit. However, an assessment of the juice content might be made to determine that a certain juice content in apples used in baking pies results in decreased bake-time, or maybe provides a preferred texture, or some other end benefit. Thus, in this example, juice content would be a value-trait. Other such value-traits for apples could include tartness, sweetness, sugar content and vitamin content. It will be appreciated that similar value-traits can be assessed for virtually any commodity, including but not limited to fruits, nuts, grains, meats, minerals, cotton, oils and metals.

Certain changes may be made in embodying the above invention without departing from the spirit and scope of the invention. It is intended that all matter contained in the above description and shown in the accompanying drawings shall be interpreted as illustrative and not meant in a limiting sense.

Having now described the features, discoveries and principles of the invention, the manner in which the inventive method of valuing, marketing and buying a commodity lot is used, and advantageous, new and useful results obtained, the new and useful elements, arrangements and combinations, are set forth in the appended claims.

It is also to be understood that the following claims are intended to cover all of the generic and specific features of the invention herein described, and all statements of the scope of the invention which, as a matter of language, might be said to fall therebetween.

Having thus described the invention, what is claimed as new and desired to be secured by Letters Patent is as follows:

1. A method of adjusting a base-value of a commodity, to account for a value-trait in a particular lot of said commodity, the method comprising the steps of:
determining an amount of a value-trait present in a particular commodity lot;
recognizing a potential production benefit to be gained as a result of said value-trait;
assigning a trait-premium to said amount based upon said potential production benefit; and
adjusting a base-value of said particular commodity lot by an increment in relation to said trait-premium.

2. The method as claimed in claim 1, wherein said potential production benefit comprises a production savings.

3. The method as claimed in claim 1, wherein said potential production benefit comprises a suitability for a specific purpose.

4. The method as claimed in claim 1, further comprising the step of segregating said particular commodity lot.

5. The method as claimed in claim 1, wherein said value-trait is selected from the group consisting of absorption, stability, peak time, extraction, flour, feed, falling number, wet gluten, mix time, dough characteristics, external, grain, texture, crumb color, volume, total bake score, and MTI.

6. The method as claimed in claim 1, wherein said value-trait is selected from the group consisting of variety, kernel weight and tempered weight.

7. The method as claimed in claim 1, further comprising the step of associating a character factor with said particular commodity lot.

8. The method as claimed in claim 7, further comprising the steps of:
assigning a value to said character factor; and
adjusting said base-value of said particular commodity lot by an increment in relation to said value.

9. The method as claimed in claim 7, wherein said character factor is selected from the group consisting of lot quantity, lot shipping logistics, lot geographic location, and lot availability.

10. A method of marketing a commodity having a value-trait, said value-trait providing a potential production benefit to a commodity purchaser, the method comprising the steps of:
posting electronically a lot-information, said lot-information comprising an amount of a value-trait for a particular lot of a commodity; and
providing a commodity purchaser access to said lot-information.

11. The method as claimed in claim 10, further comprising the steps of:
assigning a trait-premium to said amount; and
adjusting a base-value of said particular lot by an increment in relation to said trait-premium.

12. The method as claimed in claim 11, wherein said lot-information further comprises said trait-premium.

13. The method as claimed in claim 10, further comprising the step of segregating said particular lot.

14. The method as claimed in claim 10, further comprising the step of permitting said commodity purchaser to specify a parameter for said value-trait.

15. The method as claimed in claim 14, wherein said step of permitting said commodity purchaser to specify a parameter limits an inspection of said lot-information by said commodity purchaser to lot-information meeting said specified parameter.

16. The method as claimed in claim 10, further comprising the step of placing said lot-information in order according to said amount.

17. The method as claimed in claim 10, further comprising the step of permitting said commodity purchaser to request a sample of said particular lot.

18. The method as claimed in claim 10, wherein said step of electronically posting comprises posting said lot-information at an address of a global communications network.

19. The method as claimed in claim 10, wherein said value-trait is selected from the group consisting of absorption, stability, peak time, extraction, flour, feed, falling number, wet gluten, mix time, dough characteristics, external, grain, texture, crumb color, volume, total bake score, and MTI.

20. The method as claimed in claim 10, wherein said value-trait is selected from the group consisting of variety, kernel weight and tempered weight.

21. The method as claimed in claim 10, wherein said lot-information further comprises a character factor for said particular lot.

22. The method as claimed in claim 21, further comprising the steps of:
assigning a value to said character factor; and
adjusting a base-value of said particular lot by an increment in relation to said value.

23. The method as claimed in claim 21, wherein said character factor is selected from the group consisting of lot quantity, lot shipping logistics, lot geographic location, and lot availability.

24. A method of buying a commodity by inspection of electronically posted lot-information, said value-trait providing a potential production benefit to a commodity purchaser, the method comprising the steps of:
accessing a lot-information for a particular lot of a commodity, said lot-information comprising a value-trait; and
inspecting said lot-information to determine if said lot-information meets a desired criteria.

25. The method as claimed in claim 24, further comprising the step of purchasing at least a portion of said particular lot of said commodity upon said desired criteria being met.

26. The method as claimed in claim 24, further comprising the step of specifying by a commodity purchaser said desired criteria as a parameter for said value-trait.

27. The method as claimed in claim 26, wherein said step of specifying a parameter limits the inspection of said lot-information by said commodity purchaser to lot-information meeting said specified parameter.

28. The method as claimed in claim 24, further comprising the step of selecting a value-trait, wherein said lot-information is placed in order according to an amount of said selected value-trait.

29. The method as claimed in claim 24, further comprising the step of requesting a sample of said particular lot of said commodity.

30. The method as claimed in claim 24, wherein the electronic posting of said lot-information comprises posting said lot-information at an address of a global communications network.

31. The method as claimed in claim 24, wherein said value-trait is selected from the group consisting of absorption, stability, peak time, extraction, flour, feed, falling number, wet gluten, mix time, dough characteristics, external, grain, texture, crumb color, volume, total bake score, and MTI.

32. The method as claimed in claim 24, wherein said value-trait is selected from the group consisting of variety, kernel weight and tempered weight.

33. The method as claimed in claim 24, wherein said lot-information further comprises a character factor of said particular lot of said commodity.

34. The method as claimed in claim 33, wherein said character factor is selected from the group consisting of lot quantity, lot shipping logistics, lot geographic location, and lot availability.

35. A method of marketing a commodity having a value-trait, the method comprising the steps of:
recognizing a potential production benefit to be gained as a result of a value-trait in a particular lot of a commodity;
posting electronically a lot-information, said lot-information comprising said value-trait; and
allowing a commodity purchaser access to said lot-information.

36. The method as claimed in claim 35, further comprising the step of segregating said particular lot.

37. The method as claimed in claim 35, further comprising the steps of:
assigning a trait-premium to said value-trait based upon said potential production benefit; and
adjusting a base-value of said particular lot by an increment in relation to said trait premium.

38. The method as claimed in claim 37, wherein said lot-information further comprises said trait-premium.

39. The method as claimed in claim 35, wherein said potential production benefit comprises a production savings.

40. The method as claimed in claim 35, wherein said potential production benefit comprises a suitability for a specific purpose.

41. The method as claimed in claim 35, further comprising the step of testing a sample of said particular lot to determine an amount of said value-trait.

42. The method as claimed in claim 35, further comprising the step of permitting said commodity purchaser to specify a parameter for said value-trait.

43. The method as claimed in claim 42, wherein said step of permitting said commodity purchaser to specify a parameter limits the inspection of said lot-information by said commodity purchaser to lot-information meeting said specified parameter.

44. The method as claimed in claim 35, further comprising the step of placing said lot-information in order according to an amount of a selected value-trait.

45. The method as claimed in claim 35, wherein said step of electronically posting said lot-information comprises posting said lot-information at an address of a global communications network.

46. The method as claimed in claim 35, further comprising the step of permitting said commodity purchaser to request a sample of said particular lot.

47. The method as claimed in claim 35, wherein said value-trait is selected from the group consisting of absorption, stability, peak time, extraction, flour, feed, falling number, wet gluten, mix time, dough characteristics, external, grain, texture, crumb color, volume, total bake score, and MTI.

48. The method as claimed in claim 35, wherein said value-trait is selected from the group consisting of variety, kernel weight and tempered weight.

49. The method as claimed in claim 35, further comprising the steps of associating a character factor with said particular lot.

50. The method as claimed in claim 49, further comprising the steps of:
assigning a value to said character factor; and
adjusting said base-value of said particular commodity lot by an increment in relation to said value.

51. The method as claimed in claim 49, wherein said character factor is selected from the group consisting of lot quantity, lot shipping logistics, lot geographic location, and lot availability.

52. A method of marketing a commodity comprising the steps of:
posting electronically a lot-information, said lot-information comprising a growing technique for a particular lot of a commodity; and
providing a commodity purchaser access to said lot-information.

53. The method as claimed in claim 52, wherein said growing technique is selected from the group consisting of type of fertilizer used, organic growing methods, and inorganic growing methods.

54. The method as claimed in claim 52, wherein said growing technique comprises genetic engineering.

55. The method as claimed in claim 52, further comprising the step of associating a premium with said growing technique.

56. The method as claimed in claim 52, wherein said electronic posting of said lot-information comprises posting said lot-information at an address of a global communications network.

57. The method as claimed in claim 52, further comprising the steps of:
recognizing a potential production benefit to be gained as a result of a value-trait; and
posting electronically said value-trait as part of said lot-information.

58. A method of marketing a commodity comprising the steps of:
identifying a particular lot of a commodity;
posting electronically information relating to said lot of said commodity; and
allowing a commodity purchaser to track electronically a growing technique for said lot of said commodity.

59. The method as claimed in claim 58, wherein said growing technique is selected from the group consisting of type of fertilizer used, organic growing methods, and inorganic growing methods.

60. The method as claimed in claim 58, wherein said growing technique comprises genetic engineering.

61. The method as claimed in claim 58, further comprising the step of associating a premium with said growing technique.

62. The method as claimed in claim 58, wherein said electronic posting comprises posting said lot-information at an address of a global communications network.

63. The method as claimed in claim 58, further comprising the steps of:
recognizing a potential production benefit to be gained as a result of a value-trait; and
posting electronically said value-trait as part of said lot-information.
